(19) United States
(12) Patent Application Publication
(10) Pub. No.: US 2013/0114981 A1
(43) Pub. Date: May 9, 2013

(54) IMAGE-RECORDING METHOD

(71) Applicant: CANON KABUSHIKI KAISHA, Tokyo (JP)

(72) Inventor: Yuichiro Kanasugi, Tokyo (JP)

(73) Assignee: CANON KABUSHIKI KAISHA, Tokyo (JP)

(21) Appl. No.: 13/670,949

(22) Filed: Nov. 7, 2012

(30) Foreign Application Priority Data
Nov. 8, 2011 (JP) 2011-244983

(51) Int. Cl. G03G 15/16

(52) U.S. Cl. 399/296

(57) ABSTRACT

An image-recording method includes steps of supplying an intermediate transfer medium with a liquid composition containing a reaction agent that makes a coloring material contained in ink precipitate or aggregate, forming an intermediate image by supplying the ink to at least a portion of the area of the intermediate transfer medium to which the liquid composition has been supplied, and transferring the intermediate image to a recording medium. The liquid composition contains a particulate silicone rubber.

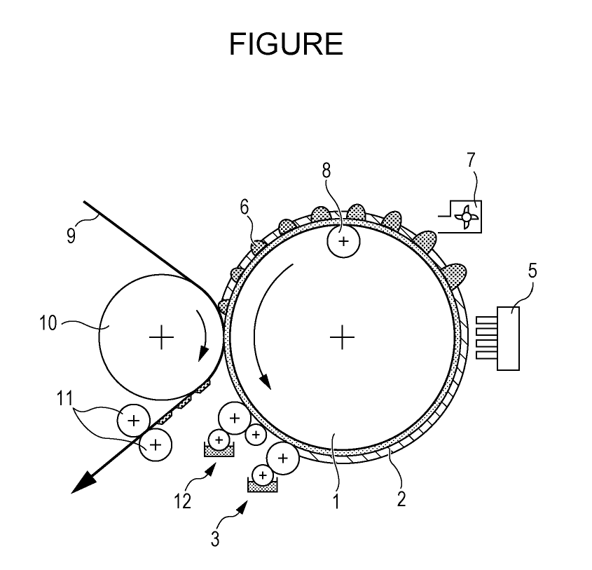

### BACKGROUND OF THE INVENTION

1. Field of the Invention

The present invention relates to an image-recording method.

2. Description of the Related Art

The intermediate-transfer image-recording method is a known image-recording method in which ink is supplied to an intermediate transfer medium to record an intermediate image and then this intermediate image is transferred to a recording medium to record an obtained image, and it has recently been argued that this method should be further improved to achieve higher image transfer performance and better image quality even at a higher transfer speed because of the increasing demand for high-speed image recording.

A typical method to improve the image transfer performance of the intermediate-transfer image-recording method is to use a low-surface-tension and water-repellent material, such as silicone rubber or fluorocarbon rubber, to form the intermediate transfer medium, and another method for the same purpose is to supply a liquid composition containing particles to the intermediate transfer medium before the recording of the intermediate image and thereby to reduce the contact area between the intermediate image and the intermediate transfer medium (Japanese Patent Laid-Open No. 2009-096175). Japanese Patent Laid-Open No. 2009-096175 describes that the image transfer performance of this image-recording method can be improved by the use of a liquid composition containing a particulate polymer such as a polyolefin, a low-molecular-weight particulate organic compound such as paraffin, or a silicone oil, a particulate inorganic compound, or the like.

Besides these, there is another known pretreatment measure taken in the intermediate-transfer image-recording method before the formation of the intermediate image, in which the intermediate transfer medium is supplied with a liquid composition containing a reaction agent that makes a coloring material contained in the ink precipitate or aggregate when it comes into contact with the ink.

### SUMMARY OF THE INVENTION

According to research by the inventors, however, the intermediate-transfer image-recording method described in Japanese Patent Laid-Open No. 2009-096175 is not enough to satisfy the current demand for high levels of image transfer performance in high-speed recording.

Aspects of the present invention therefore provide an intermediate-transfer image-recording method in which the intermediate image can be completely transferred even at a high transfer speed.

The image-recording method according to an aspect of the present invention includes steps of supplying an intermediate transfer medium with a liquid composition containing a reaction agent that makes a coloring material contained in ink precipitate or aggregate, forming an intermediate image by supplying the ink to at least a portion of the area of the intermediate transfer medium to which the liquid composition has been supplied, and transferring the intermediate image to a recording medium. The liquid composition contains a particulate silicone rubber.

As a result, there is provided an image-recording method in which the intermediate image can be completely transferred.

Further features of the present invention will become apparent from the following description of exemplary embodiments with reference to the attached drawing.

### BRIEF DESCRIPTION OF THE DRAWINGS

The FIGURE is a schematic cross-sectional diagram illustrating a typical constitution of a recording apparatus used in aspects of the present invention.

### DESCRIPTION OF THE EMBODIMENTS

The basic concept, which should be understood in advance of the details of embodiments, is the following.

When an intermediate image is transferred from an intermediate transfer medium, the releasing properties of the intermediate transfer medium should be sufficiently good, or incomplete transfer may occur that affects the image quality.

The following details aspects of the present invention with reference to embodiments. The image-recording method according to an aspect of the present invention, which includes supplying a liquid composition containing a particulate silicone rubber to the intermediate transfer medium before recording the intermediate image, improves the completeness of the transfer of the intermediate image (intermediate image transfer performance).

Possible reasons for this advantage, or the improved intermediate image transfer performance resulting from the use of a liquid composition containing a particulate silicone rubber, are the following.

To improve the intermediate image transfer performance, it is important that the intermediate image can be easily released from the intermediate transfer medium and that the released intermediate image can firmly adhere to the recording medium.

The surface of each silicone rubber particle is highly releasable from the intermediate transfer medium, and thus silicone rubber particles interposed between the intermediate image and the intermediate transfer medium help the intermediate image leave the intermediate transfer medium. The inventors have also found that the adhesion between the intermediate image and the recording medium can be improved by transferring the intermediate image to the recording medium while compressing the intermediate image between the intermediate transfer medium and the recording medium at a certain pressure (transfer pressure) because the silicone rubber particles are deformed by the pressure. Presumably, the particulate silicone rubber works in these two ways during the image transfer process and thereby improve the intermediate image transfer performance.

The FIGURE is a schematic cross-sectional diagram illustrating a typical constitution of a recording apparatus used in embodiments of the present invention. The intermediate transfer medium 1 is a rotor and has a surface layer 2. Around the intermediate transfer medium 1, some units for basic processes are arranged: a liquid-composition-supplying unit 3, which can supply the liquid composition, an inkjet head 5, which can form an intermediate image, and a transfer roller 10, which can transfer the intermediate image to a recording medium. There may be a water-removing unit 7 and a heating unit 8 between the inkjet head 5 and the transfer roller 10 so that the water content of supplied ink can be reduced in a shorter period of time. Likewise, there may be a cleaning unit 12 between the transfer roller 10 and the liquid-composition-supplying unit 3 so that ink residue left after each image transfer cycle can be removed from the intermediate transfer medium 1, and there may be a fixing roller 11 so that the image transferred to the recording medium 9 can be fixed in a shorter period of time.

The intermediate transfer medium 1 rotates in the direction indicated by the arrow in the drawing, and the liquid-composition-supplying unit 3 supplies the liquid composition to the surface layer 2. Then, the inkjet head 5, which has multiple nozzle rows for multiple colors, supplies ink in response to image data and thereby records an intermediate image 6. The recorded intermediate image 6 is treated at the water-removing unit 7 and the heating unit 8 (if they are present) to have a viscosity suitable for transfer, further improving the image transfer performance. The intermediate image 6 is then transferred by the transfer roller 10 to the recording medium 9. After this transfer process, the cleaning unit 12 (if present) may clean the surface of the intermediate transfer medium 1. The intermediate transfer medium 1 repeatedly rotates and thereby the cycles each including the above operations are repeated. As a result, a obtained image is repeatedly produced on the recording medium 9.

The intermediate transfer medium may be like a roller, a belt, or any other appropriate shape. For example, an intermediate transfer drum made of light metal such as aluminum alloys can have favorable characteristics including sufficient rigidity against the pressure applied during the transfer process, dimensional accuracy, low rotational inertia, and so forth.

The surface layer of the intermediate transfer medium may be ink-absorbent or not. Like a surface layer that does not absorb ink, an ink-adsorbent surface layer also allows the intermediate transfer medium to be repeatedly used if the absorbed ink can be removed from the surface layer by a cleaning process. The surface layer of the intermediate transfer medium may be treated in advance to have improved releasing properties; this improves the transfer efficiency and makes it easier to clean the surface layer. The term releasing properties, as used herein, refers to the ability of a surface to easily release the substance existing thereon, such as ink or ingredients of a liquid composition. Better releasing properties of the surface layer of the intermediate transfer medium usually lead to a higher transfer efficiency and a greater ease of cleaning, but in some cases may cause the ink or the liquid composition to be seriously repelled and thereby the intermediate image not to maintain its integrity. Thus, the critical surface tension can be equal to or smaller than 30 mN/m, and the water contact angle can be equal to or greater than 75°. In more specific terms, the surface layer of the intermediate transfer medium can be formed by treatment with Teflon®, supply with silicone oil, or any other suitable method.

The liquid-composition-supplying unit may be based on application, inkjet, or any other suitable mode of operation. Although a roll coater is illustrated in the FIGURE, this is not the only operating mechanism of this unit; a spray coater, a slit coater, and other suitable mechanisms can be used.

The inkjet head can eject ink through multiple nozzles on the basis of the inkjet principle, and examples include thermal, piezoelectric, electrostatic, MEMS (microelectromechanical system), and other inkjet heads. The inkjet head may be a line-printing head or a serial-printing head.

The entire process from forming an intermediate image on the intermediate transfer medium to transferring the intermediate image can be roughly divided into the following three steps (a) to (c). The following describes each step in detail. In the following, the term intermediate transfer medium surface refers to the surface of the surface layer of the intermediate transfer medium.

### (a) Supplying the Liquid Composition

In step (a), as illustrated in the FIGURE, the liquid composition is supplied to the surface layer 2 of the intermediate transfer medium 1 using the liquid-composition-supplying unit 3. The following describes examples of the substances that can be contained in this liquid composition.

The liquid composition contains one or more reaction agents that make a coloring material or materials contained in the ink precipitate or aggregate. For dyes as coloring materials, reaction agents that make the dye precipitate out of the ink are used. For pigments as coloring materials, reaction agents that initiate a reaction that makes the pigment particles aggregate out of the ink are used. These actions of the reaction agent or reaction agents increase the viscosity of the ink and thereby help the intermediate image stay on the intermediate transfer medium. Examples of suitable reaction agents include polyvalent metal ions, organic acids, and so forth.

Examples of suitable polyvalent metal ions include Ca²⁺, Cu²⁺, Ni²⁺, Mg²⁺, Zn²⁺, and other divalent metal ions, Fe³⁺, Al³⁺, and other trivalent metal ions, and so forth. These ions can be used alone or in combination of two or more kinds, and the ion or ions in the liquid composition may be in a salt form or any other suitable form. Examples of the ions that can form salts with these polyvalent metal ions include Cl⁻, NO³⁻, SO⁴⁻, I⁻, Br⁻, ClO³⁻, RCOO⁻ (R is an alkyl group having 1 to 20 carbon atoms), and so forth. When a polyvalent metal ion or ions are used, the content may be in the range of 5.0% by mass to 70.0% by mass, both inclusive, relative to the total mass of the liquid composition.

Organic acids can rapidly react with coloring materials existing in ink and thus can be used as the reacting component. All hitherto known organic acids can be used, including carboxylic acids, sulfonic acids, and so forth. Specific examples include the following: polyacrylic acid, acetic acid, methanesulfonic acid, glycolic acid, malonic acid, malic acid, maleic acid, ascorbic acid, succinic acid, glutaric acid, fumaric acid, citric acid, tartaric acid, lactic acid, sulfonic acid, levulinic acid, orthophosphoric acid, pyrrolidonecarboxylic acid, pyronecarboxylic acid, pyrrolecarboxylic acid, furancarboxylic acid, pyridinecarboxylic acid, coumarinic acid, thiophenecarboxylic acid, and nicotinic acid, their derivatives or salts, and similar compounds. The use of levulinic acid, which is unlikely to precipitate out of the liquid composition, can improve the storage stability of the liquid composition. These compounds can be used alone or in combination of two or more kinds.

When an organic acid or acids are used as the reacting component, the pH of the liquid composition is may be in the range of 1.0 to 4.0, both inclusive, such as 1.0 to 3.5, both inclusive, and even 1.0 to 3.0, both inclusive, and the organic acid content may be in the range of 5.0% by mass to 90.0% by mass, both inclusive, relative to the total mass of the liquid composition.

The liquid composition may contain one or more polymers so that the image transfer performance and the robustness of the obtained image can be improved. All kinds of polymers that can coexist with the reaction agent or reaction agents are suitable, including polyvinyl alcohol, polyvinyl pyrrolidone, oxazoline, carbodiimide, and so forth.

The liquid composition may contain one or more neutralizing agents to adjust the hydrogen ion concentration (pH). Examples of suitable neutralizing agents include potassium hydroxide, calcium hydroxide, sodium hydroxide, hydrochloric acid, sulfuric acid, nitric acid, methanesulfonic acid, and so forth.

The liquid composition contains a particulate silicone rubber. The particulate silicone rubber, as used herein, represents polymers having a linear organopolysiloxane block defined by formula (I) and forming particles by aggregation:

—(R₂SiO)ₐ— (1)

(where R is a monovalent organic group having 1 to 20 carbon atoms selected from alkyl groups [e.g., methyl, ethyl, propyl, and butyl groups], aryl groups [e.g., phenyl and tolyl groups], alkenyl groups [e.g., vinyl and allyl groups], aralkyl groups [e.g., β-phenylethyl and β-phenylpropyl groups], monovalent halogenated hydrocarbon groups [e.g., chloromethyl and 3,3,3-trifluoropropyl groups], organic groups having a reactive group [e.g., epoxy-, amino-, mercapto-, acryloxy-, and methacryloxy-containing groups], and other similar groups, one or a combination of two or more of these organic groups can be present, and the subscript a is in the range of 5 to 5,000). The polymers having such a linear organopolysiloxane block form elastic particles by aggregation.

The particulate silicone rubber, constituted as above, may contain silicone oil, organosilane, inorganic or organic particles, or the like inside the particles.

This type of particulate silicone rubber can be prepared by, for example, a method described in Japan Patent No. 2832143. Examples of commercially available products include KMP-597 (Shin-Etsu Chemical), EP-5500 and 33 ADDITIVE (Dow Corning Toray), and so forth.

The volume-average particle diameter of the particulate silicone rubber may be in the range of 0.3 μm to 15.0 μm, both inclusive, such as 0.3 μm to 5.0 μm, both inclusive. A volume-average particle diameter smaller than 0.3 μm can cause the particles not to be well dispersed in the liquid composition and thereby to be unevenly distributed in the applied coating, resulting in insufficient improvement of the image transfer performance. However, a volume-average particle diameter exceeding 15.0 μm can cause the particles to have a problematically small total surface area compared with ones with a smaller diameter used in the same amount in parts by mass. Such a small total surface area of the particulate silicone rubber can result in insufficiently improved image transfer performance because the releasing properties of the particulate silicone rubber, which work on the surface of the particles as mentioned above, are not enough. However, increasing the amount of the particulate silicone rubber for this reason, or to ensure adequate image transfer performance, means reducing the relative amounts of the other ingredients in the ink. This can cause, for example, a shortage of the reaction agent or reaction agents for making a coloring material or materials of the ink precipitate or aggregate. A shortage of the reaction agent or reaction agents can cause incomplete precipitation or aggregation reaction and thereby a lower viscosity of the ink than necessary. The transferred image can be blurred, and the improvement of the image transfer performance can therefore be insufficient.

The particulate silicone rubber content of the liquid composition may be equal to or higher than 10% by mass, such as equal to or higher than 15% by mass, and even equal to or lower than 60% by mass, such as equal to or lower than 50% by mass. A particulate silicone rubber content lower than 10% by mass can cause a smaller increase in releasing properties than necessary and thereby insufficient improvement of the image transfer performance. A particulate silicone rubber content exceeding 60% by mass, which leads to reduced relative amounts of the reaction agent or reaction agents and all other ingredients and related effects, can cause a lower viscosity of the ink than necessary. The transferred image can be blurred, and the improvement of the image transfer performance can therefore be insufficient.

The silicone rubber particles may be partially or completely coated with a polyorganosylsesquioxane polymer. Coating the particles with a polyorganosylsesquioxane polymer improves their dispersibility in the liquid composition because the polyorganosylsesquioxane molecules repel each other and the silicone rubber particles accordingly repulse each other. Enhancing the dispersibility of the particulate silicone rubber in this way prevents uneven transfer issues due to incomplete image transfer because when the liquid composition is supplied to the intermediate transfer medium, the particles contained in it are uniformly distributed on the surface of the transfer medium and thereby improve the image transfer performance of the transfer medium over its entire surface.

Particulate silicone rubbers coated with a polyorganosylsesquioxane polymer in this way can be prepared by, for example, a method described in Japan Patent No. 2832143. Examples of commercially available products include X-52-7030, KMP-605, KMP-600, KMP-601, and KMP-602 (Shin-Etsu Chemical) and so forth.

The solvent for the liquid composition may be water or an organic solvent. The dispersibility of the particulate silicone rubber can be improved by the use of an organic solvent, in particular, ethanol, methanol, propanol, or any other alkyl alcohol.

Besides the ingredients mentioned above, the liquid composition may contain additives including antirusts, preservatives, antimolds, antioxidants, reduction inhibitors, surfactants, and so forth.

### (b) Forming the Intermediate Image

In step (b), ink of a predetermined color is ejected from the inkjet head 5 in response to image data to the intermediate transfer medium supplied with the liquid composition and thereby an intermediate image is formed on the intermediate transfer medium.

The kind of the ink used in step (b) is not critical; all kinds of aqueous inks, which are composed of a coloring material or materials (usually dyes or pigments) and an aqueous liquid medium for dissolving and/or dispersing them, can be used. The use of a pigment or pigments leads to improved robustness of the obtained image.

Examples of suitable dyes include C.I. Direct Blue 6, 8, 22, 34, 70, 71, 76, 78, 86, 142, and 199, C.I. Acid Blue 9, 22, 40, 59, 93, 102, 104, 117, 120, 167, and 229, C.I. Direct Red 1, 4, 17, 28, 83, and 227, C.I. Acid Red 1, 4, 8, 13, 14, 15, 18, 21, 26, 35, 37, 249, 257, and 289, C.I. Direct Yellow 12, 24, 26, 86, 98, 132, and 142, C.I. Acid Yellow 1, 3, 4, 7, 11, 12, 13, 14, 19, 23, 25, 34, 44, and 71, C.I. Food Black 1 and 2, C.I. Acid Black 2, 7, 24, 26, 31, 52, 112, and 118, and so forth.

Examples of suitable pigments include C.I. Pigment Blue 1, 2, 3, 15:3, 16, and 22, C.I. Pigment Red 5, 7, 12, 48, 57, 112, and 122, C.I. Pigment Yellow 1, 2, 3, 13, 16, and 83, and Carbon Black Nos. 2300, 900, 33, 40, and 52, as well as MA7, MA8, and MCF88 (Mitsubishi Chemical), RAVEN 1255 (Columbian Chemicals), REGAL 330R, REGAL 660R, and MOGUL (Cabot), Color Black FW1, FW18, 5170, and 5150 and Printex 35 (Degussa), and so forth.

These pigments can be used in various forms including self-dispersion pigment, polymer dispersion, microcapsules, and so forth. Examples of the dispersants that can be used with these pigments include water-soluble polymers, such as vinyl water-soluble polymers and block or random copolymers and their salts of the following compounds: styrene and its derivatives, vinylnaphthalene and its derivatives, α,β-ethylenic unsaturated carboxylic acid-aliphatic alcohol esters, acrylic acid and its derivatives, maleic acid and its derivatives, itaconic acid and its derivatives, and fumaric acid and its derivatives. The weight-average molecular weight of the dispersant polymer or polymers may be in the range of 1,000 to 15,000, both inclusive. These ink materials can be used in combination; dyes, pigments, and dispersants can be used alone or as a mixture of two or more kinds, and different dispersion forms can be blended.

In addition to the dispersant polymer(s), one or more water-soluble polymers may be contained in the ink so that the robustness of the obtained image can be improved.

Furthermore, the ink may contain one or more water-soluble organic solvents. Examples of suitable water-soluble organic solvents include polyethylene glycol, polypropylene glycol, ethylene glycol, propylene glycol, butylene glycol, triethylene glycol, thiodiglycol, hexylene glycol, diethylene glycol, ethylene glycol monomethyl ether, diethylene glycol monomethyl ether, glycerol, and so forth. Mixtures of two or more of these can also be used. Alcohols such as ethyl alcohol and isopropyl alcohol, surfactants, and other agents for modifying the viscosity, surface tension, and other characteristics can also be added to the ink.

The proportion of the ingredients of the ink is not critical and can be appropriately selected depending on the mode of inkjet recording chosen, the ejection capacity of the inkjet head, the nozzle diameter, and other factors that determine whether the ink can be ejected. A possible proportion of the ink is the following (all on a mass basis): 1 to 10% of coloring material(s), 0.1 to 20% of a polymer component, 5 to 40% of solvent(s), 0.01 to 5% of surfactant(s), and purified water as balance.

### (c) Transferring the Image

In step (c), the intermediate image 6 is transferred from the intermediate transfer medium 1 to the recording medium 9 using the transfer roller 10. The kind of the recording medium is not critical. Even printing paper relatively impermeable with ink, films and other ink-repellent media, and similar recording media can be used.

During each image transfer cycle, the recording medium may be pressed against the intermediate image under the right amount of pressure. Specific examples of the methods to do this include using a roller or similar equipment that operates as the intermediate transfer medium rotates, arranging a presser to face the intermediate transfer medium and making it move back and forth in the direction perpendicular to the movement of the transfer medium to give quick presses, and so forth. The amount of pressure may be in the range of 5 to 100 msec.

### EXAMPLES

The following provides some examples and comparative examples of the intermediate-transfer image-recording method according to an aspect of the present invention to describe aspects of the invention in more detail. The units of measurement “parts” and “%” are all on a mass basis unless otherwise specified. In the following examples and comparative examples, the volume-average particle diameter of the particulate silicone rubber was measured by dispersing the particles in a methanol solution and analyzing the dispersion by the Coulter principle.

### Example 1

### (a) Supplying the Liquid Composition

An aluminum drum as the intermediate transfer medium 1 was coated with a 0.5-mm thick siloxane layer as the surface layer 2. The siloxane layer was made from a hydrolysable organic silicon compound.

The process of preparing the siloxane layer from the hydrolysable organic silicon compound was as follows. First, glycidoxypropyltriethoxysilane and methyltriethoxysilane were mixed in a molar ratio of 1:1, and the mixture was heated under reflux in water for at least 24 hours in the presence of hydrochloric acid as the catalyst and thereby solution containing a hydrolysable condensate was obtained. The hydrolysable-condensate solution was then diluted with methyl isobutyl ketone to a concentration of 15% by mass, and exactly 5% by mass of SP150 cationic photopolymerization initiator (ADEKA) was added. The obtained liquid was applied to the aluminum drum to form a coating on the surface, and the coating was fixed to the drum by plasma treatment. The fixed coating was further exposed to radiation from a UV lamp and heated at 135° C. for 2.5 hours to be cured as the surface layer 2. The thickness of the surface layer 2 was approximately 0.1 μm.

Liquid Composition 1, the formula of which is provided below, was thoroughly stirred and pressed through a microfilter with a pore size of 3.0 μm (FM300, FUJIFILM Corporation), and the filtrate was applied to the surface of the intermediate transfer medium with a roll coater as the liquid-composition-supplying unit 3. The thickness of the applied filtrate was adjusted so that the density should be about 1.0 g/m².

### Liquid Composition 1

Levulinic acid: 15 parts
Potassium hydroxide: 1 part
Fluorosurfactant 1 (Zonyl FSO-100): 3 parts
Ethanol: 65 parts
Ion-exchanged water: 0 part
A particulate silicone rubber: 16 parts

### (b) Forming the Intermediate Image

A mirror image of a pattern was formed on the intermediate transfer medium, which had a coating of the liquid composition supplied in step (a), by ejecting ink onto the transfer medium using an inkjet head 5 (nozzle density: 1200 dpi; ejection volume: 4 pL; operating frequency: 12 kHz). The ink was prepared as follows.

### Preparation of the Ink

Black ink to form solid images was prepared by mixing two dispersions, which were a liquid dispersion containing a black pigment and a particulate-polymer dispersion, separately obtained as follows.

### Preparation of the Black-Pigment Liquid Dispersion

A styrene-ethyl acrylate-acrylic acid copolymer (acid value: 150; weight-average molecular weight: 8,000) as pigment dispersant was dissolved in water, and the obtained aqueous solution, the solid content of which was 20%, was neutralized with potassium hydroxide. Ten (10) parts of carbon black (Monarch 1100, Cabot), 15 parts of the pigment-dispersant aqueous solution, and 75 parts of purified water were mixed, and the obtained mixture was put into a batch-type vertical sand mill (AIMEX Co., Ltd.). The sand mill was loaded with 200 parts of 0.3-mm diameter zirconia beads, and the beads were dispersed for 5 hours with water cooling. The obtained liquid dispersion was centrifuged, and coarse particles were removed. In this way, a black-pigment liquid dispersion was obtained with a pigment content of approximately 10%.

### Preparation of the Particulate-Polymer Dispersion

Eighteen (18) parts of ethyl methacrylate, 2 parts of 2,2′-azobis(2-methylbutyronitrile), and 2 parts of n-hexadecane were mixed, and the mixture was stirred for 0.5 hour. The stirred mixture was added dropwise to 78 parts of a 6% aqueous solution of NIKKOL BC20 (Nikko Chemicals Co., Ltd.), an emulsifier, and the resulting fluid was stirred for 0.5 hour. The stirred fluid was sonicated using an ultrasonic generator for 3 hours. After 3 hours of polymerization reaction in a nitrogen atmosphere at 85° C., the fluid was allowed to cool to room temperature and filtered. In this way, a particulate-polymer dispersion was obtained with a concentration of approximately 20%. The weight-average molecular weight and the dispersed particle diameter of the particulate polymer were approximately 1,100,000 and approximately 140 nm, respectively.

### Preparation of the Ink

The black-pigment liquid dispersion and the particulate-polymer dispersion described above were mixed with other ingredients in accordance with the following proportion.
Black-pigment liquid dispersion: 20%
Particulate-polymer dispersion: 50%
Diethylene glycol: 10%
Acetylenol E100:1%
Ion-exchanged water: 19%

The mixture was thoroughly stirred and pressed through a microfilter with a pore size of 3.0 μm (FUJIFILM Corporation). In this way, the black ink was prepared.

In the examples and comparative examples described herein, the pattern image mentioned above was formed as solid images each having dimensions of 10 mm by 10 mm for the sake of simplicity. The recording duty was 100% or 200%. A recording duty of 100% refers to a recording density where all dots in an area of 1200 dpi by 1200 dpi are supplied with one 4-pL drop of ink, and 200% means that all dots in an area of 1200 dpi by 1200 dpi are painted with two 4-pL drops of ink.

The inkjet head 5 was an on-demand line-printing head based on electrothermal converters and had nozzle rows arranged in parallel with the direction of the rotational axis of the intermediate transfer medium.

Turning back to the description of step (b), the formed intermediate image was heated and dried using a water-removing unit 7 and a heating unit 8 and then transferred. At the water-removing unit 7, the intermediate image was blown with warm air at 25° C. for 50 seconds and thereby the right amounts of ethanol, water, and other solvent content were evaporated.

### (c) Transferring the Image

This constitution enables efficient image transfer by compressing the intermediate image in a way that the intermediate transfer medium 1 on which the intermediate image has been formed is pressed against a recording medium 9 conveyed on a pressure roller as the transfer roller 10 that rotates around a supporting member provided through its center.

In the examples and comparative examples described herein, the time of application of transfer pressure was 10 msec (feeding speed: 1 m/sec; length of the nip between the rollers: 10 mm), and the recording medium was printing paper (Aurora Coat available from Nippon Paper Group, Inc., 127.9 g/m²).

This recording medium was used in the form of a scroll; however, equal-sized pieces of paper can also be used.

According to this embodiment, a cleaning unit 12 is also provided so that after the transfer of an intermediate image to the recording medium, the intermediate transfer medium 1 can be ready for the formation of the next image for repeated use. The apparatus illustrated in the FIGURE has a molleton-covered roller arranged to be continuously dampened with ion-exchanged water and to be intermittently brought into contact with the surface.

Examples 2 to 9 and Comparative Examples 1 to 6 are the same as Example 1 except for the formula of the liquid composition. Table 1 lists the formulae of Liquid Compositions 1 to 9, which correspond to Examples 1 to 9, and the formulae of Comparative Liquid Compositions 1 to 6, which correspond to Comparative Examples 1 to 6.

TABLE 1

| | | | | | | | | | | | Ion- |
|---|---|---|---|---|---|---|---|---|---|---|---|
| | | | Neutralizing | | | | | | Organic | | exchanged |
| | Ink thickener | | agent | | Particles | | Surfactant | | solvent | | water |
| | Name | Parts | Name | Parts | Name | Parts | Name | Parts | Name | Parts | Parts |
| Liquid | Levulinic | 15 | Potassium | 1 | Particles 1 | 16 | Fluorosurfactant 1 | 3 | Ethanol | 65 | 0 |
| Composition 1 | acid | | hydroxide | | | | | | | | |
| Liquid | Levulinic | 15 | Potassium | 1 | Particles 1 | 16 | Fluorosurfactant 1 | 3 | — | — | 65 |
| Composition 2 | acid | | hydroxide | | | | | | | | |
| Liquid | Levulinic | 15 | Potassium | 1 | Particles 2 | 16 | Fluorosurfactant 1 | 3 | Ethanol | 65 | 0 |
| Composition 3 | acid | | hydroxide | | | | | | | | |
| Liquid | Levulinic | 15 | Potassium | 1 | Particles 3 | 16 | Fluorosurfactant 1 | 3 | Ethanol | 65 | 0 |
| Composition 4 | acid | | hydroxide | | | | | | | | |
| Liquid | Levulinic | 15 | Potassium | 1 | Particles 4 | 16 | Fluorosurfactant 1 | 3 | Ethanol | 65 | 0 |
| Composition 5 | acid | | hydroxide | | | | | | | | |
| Liquid | Levulinic | 15 | Potassium | 1 | Particles 5 | 16 | Fluorosurfactant 1 | 3 | Ethanol | 65 | 0 |
| Composition 6 | acid | | hydroxide | | | | | | | | |
| Liquid | Levulinic | 15 | Potassium | 1 | Particles 6 | 16 | Fluorosurfactant 1 | 3 | Ethanol | 65 | 0 |
| Composition 7 | acid | | hydroxide | | | | | | | | |
| Liquid | Levulinic | 15 | Potassium | 1 | Particles 7 | 16 | Fluorosurfactant 1 | 3 | Ethanol | 65 | 0 |
| Composition 8 | acid | | hydroxide | | | | | | | | |
| Liquid | Levulinic | 15 | Potassium | 1 | Particles 1 | 5 | Fluorosurfactant 1 | 3 | Ethanol | 75 | 0 |
| Composition 9 | acid | | hydroxide | | | | | | | | |
| Comp. Liquid | Levulinic | 15 | Potassium | 1 | Comp. | 40 | Fluorosurfactant 1 | 3 | — | — | 41 |
| Composition 1 | acid | | hydroxide | | Particles 1 | | | | | | |
| Comp. Liquid | Levulinic | 15 | Potassium | 1 | Comp. | 80 | Fluorosurfactant 1 | 3 | — | — | 1 |
| Composition 2 | acid | | hydroxide | | Particles 2 | | | | | | |
| Comp. Liquid | Levulinic | 15 | Potassium | 1 | Comp. | 52 | Fluorosurfactant 1 | 3 | — | — | 29 |
| Composition 3 | acid | | hydroxide | | Particles 3 | | | | | | |
| Comp. Liquid | Levulinic | 15 | Potassium | 1 | Comp. | 41 | Fluorosurfactant 1 | 3 | — | — | 40 |
| Composition 4 | acid | | hydroxide | | Particles 4 | | | | | | |
| Comp. Liquid | Levulinic | 15 | Potassium | 1 | — | — | Fluorosurfactant 1 | 3 | Ethanol | 81 | 0 |
| Composition 5 | acid | | hydroxide | | | | | | | | |
| Comp. Liquid | — | — | — | — | Particles 1 | 16 | Fluorosurfactant 1 | 3 | Ethanol | 81 | 0 |
| Composition 6 | | | | | | | | | | | |

Table 2 lists the formulae of Particles 1 to 7 and Comparative Particles 1 to 4, which were used in the liquid compositions and comparative liquid compositions.

TABLE 2

| | | | | Volume-average | |
|---|---|---|---|---|---|
| | | | Polyorganosylsesquioxane | particle | |
| | Material name | Type | polymer coated | diameter | |
| Particles 1 | X-52-7030 | Particulate Silicone | Yes | 0.8 | μm |
| | (Shin-Etsu Chemical) | rubber | | | |
| Particles 2 | KMP-605 | Particulate Silicone | Yes | 2.0 | μm |
| | (Shin-Etsu Chemical) | rubber | | | |
| Particles 3 | KMP-600 | Particulate Silicone | Yes | 5.0 | μm |
| | (Shin-Etsu Chemical) | rubber | | | |
| Particles 4 | KMP-601 | Particulate Silicone | Yes | 12.0 | μm |
| | (Shin-Etsu Chemical) | rubber | | | |
| Particles 5 | KMP-602 | Particulate Silicone | Yes | 30.0 | μm |
| | (Shin-Etsu Chemical) | rubber | | | |
| Particles 6 | KMP-597 | Particulate Silicone | No | 5.0 | μm |
| | (Shin-Etsu Chemical) | rubber | | | |
| Particles 7 | KMP-598 | Particulate Silicone | No | 13.0 | μm |
| | (Shin-Etsu Chemical) | rubber | | | |
| Comp. | CHEMIPEARL W400 | Particulate Polyolefin | — | 4.0 | μm |
| Particles 1 | (Mitsui Chemicals) | emulsion (40% solids) | | | |
| Comp. | Particulate polymer | Particulate acrylic | — | 0.14 | μm |
| Particles 2 | dispersion | polymer | | | |
| | contained in the ink | emulsion (20% solids) | | | |
| Comp. | SNOWTEX AK-YL | Particulate silica | — | 0.07 | μm |
| Particles 3 | (Nissan Chemical | emulsion (31% solids) | | | |
| | Industries) | | | | |
| Comp. | IE-7046T | Particulate Silicone oil | — | 0.2 | μm |
| Particles 4 | (Dow Corning Toray) | emulsion (39% solids) | | | |

### Evaluation

Table 3 summarizes the results from image transfer performance testing with each of Liquid Compositions 1 to 9 and Comparative Liquid Compositions 1 to 6.

### Image Transfer Performance

The evaluations on image transfer performance for the examples and comparative examples described herein were made on the basis of the percentage area of ink remaining on the intermediate transfer medium after an image transfer cycle. More specifically, the percentage area of remaining ink was calculated in the following way and used to evaluate the image transfer performance as the image transfer performance is inversely correlated with the percentage area of remaining ink.

After the intermediate image was transferred to the recording medium, the surface of the intermediate transfer medium was observed under an optical microscope. The observed surface image of the intermediate transfer medium was binarized on image-processing software (Image-Pro Plus, Media Cybernetics, Inc.) to identify regions where the ink was still present. The percentage of the total area of the regions with remaining ink in a unit area of the surface of the intermediate transfer medium was calculated, and the obtained percentage area of remaining ink was assessed by the following criteria. In aspects of the present invention, levels A to C are acceptable, and levels D and E are unacceptable.

A: The percentage area of the ink for the intermediate image remaining on the intermediate transfer medium is ≧0% to <5%.

B: The percentage area of the ink for the intermediate image remaining on the intermediate transfer medium is ≧5% to <10%.

C: The percentage area of the ink for the intermediate image remaining on the intermediate transfer medium is ≧10% to <15%.

D: The percentage area of the ink for the intermediate image remaining on the intermediate transfer medium is ≧15% to <60%.

E: The percentage area of the ink for the intermediate image remaining on the intermediate transfer medium is ≧60%.

TABLE 3

| | | Image transfer | |
|---|---|---|---|
| | | performance | |
| | | 100% Duty | 200% Duty |
| Example 1 | Liquid Composition 1 | A | A |
| Example 2 | Liquid Composition 2 | A | A |
| Example 3 | Liquid Composition 3 | A | A |
| Example 4 | Liquid Composition 4 | A | A |
| Example 5 | Liquid Composition 5 | A | B |
| Example 6 | Liquid Composition 6 | B | C |
| Example 7 | Liquid Composition 7 | B | C |
| Example 8 | Liquid Composition 8 | C | C |
| Example 9 | Liquid Composition 9 | C | C |
| Comparative | Comp. Liquid | C | D |
| Example 1 | Composition 1 | | |
| Comparative | Comp. Liquid | D | D |
| Example 2 | Composition 2 | | |
| Comparative | Comp. Liquid | D | E |
| Example 3 | Composition 3 | | |
| Comparative | Comp. Liquid | D | E |
| Example 4 | Composition 4 | | |
| Comparative | Comp. Liquid | E | E |
| Example 5 | Composition 5 | | |
| Comparative | Comp. Liquid | E | E |
| Example 6 | Composition 6 | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-244983 filed Nov. 8, 2011, which is hereby incorporated by reference herein in its entirety.

What is claimed is:

1. An image-recording method comprising steps of:
supplying an intermediate transfer medium with a liquid composition containing a reaction agent that makes a coloring material contained in ink precipitate or aggregate;
forming an intermediate image by supplying the ink to at least a portion of an area of the intermediate transfer medium to which the liquid composition has been supplied; and
transferring the intermediate image to a recording medium,
wherein the liquid composition contains a particulate silicone rubber.

2. The image-recording method according to claim 1, wherein the particulate silicone rubber has a polyorganosylsesquioxane polymer on a surface thereof.

3. The image-recording method according to claim 1, wherein the particulate silicone rubber has a volume-average particle diameter in a range of 0.3 μm to 15.0 μm, both inclusive.

4. The image-recording method according to claim 1, wherein the particulate silicone rubber is present in an amount of 10% by mass to 60% by mass, both inclusive, relative to the liquid composition.
